(19) United States
(12) Patent Application Publication
(10) Pub. No.: US 2005/0205628 A1
(43) Pub. Date: Sep. 22, 2005

(54) Repositionable carrier rack assembly for an all terrain vehicle (ATV)

(76) Inventor: Bret A. Lehmann, Eau Claire, WI (US)

Correspondence Address: Bret A. Lehmann, 3119 Leslie Lane, Eau Claire, WI, 54703, US

(21) Appl. No.: 10/804,607

(22) Filed: Mar. 18, 2004

(51) Int. Cl. B60R 7/00; B60R 9/00; B60R 11/00

(52) U.S. Cl. 224/401

(57) ABSTRACT

A repositionable carrier rack assembly for an all terrain vehicle (ATV) provides ATVs with rear mounted and accessed fuel tanks a horizontal cargo carrying rack structure to which gear and cargo can be secured and of which can be easily repositioned when in a loaded or unloaded state. The horizontal cargo carrying portion remains horizontal while being repositioned from a first extreme position suitable for operating the ATV to a second extreme position that allows full access to the fuel filler inlet located beneath it. Mechanical advantage attained by use of a spring mechanism or pressurized strut mechanism may be employed to assist the person repositioning the aforementioned carrier rack assembly.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

This invention relates generally to carrier racks which are attached to the rear frame of all terrain vehicles (ATVs) and are used to secure gear or cargo during utilitarian use or recreational riding.

The use of all terrain vehicles (ATVs) as a means of utility, recreation, and competitive racing has continually increased in popularity for many years. Many ATVs are now equipped by the manufacturer with carrier racks designed to secure gear or cargo during use. These are mainly four-wheel drive ATVs that were originally designed as “workhorses” or “utility” vehicles, but some two-wheel drive ATVs that were originally designed as “dual purpose recreational” or “sport/utility” vehicles are similarly equipped with carrier racks. However, most if not all, “sport” ATVs that were originally designed for racing are not equipped with carrier racks by the manufacturer. These vehicles generally have a simple U-shaped grab bar with an integrated flag mast attachment point connected to the rear of their frame.

Many of these “sport” ATVs are purchased by consumers who never intend to race them. These consumers have demanded aftermarket accessory carrier racks for securing gear or cargo and several manufacturers have answered that demand by producing rigidly designed carrier racks that replace the original grab bars that stick out the back of these “sport” ATVs. Recently, an ATV manufacturer has begun production of a “sport” ATV that has a rear mounted and accessed fuel tank. This poses a problem for consumers who want a rear carrier rack that remains as close inward to the original length dimensions of the ATV for both weight distribution and aesthetic reasons. If the carrier rack is too far inward it hinders access to the fuel filler inlet on the ATV, if it is too far outward it causes weight distribution problems and gives the machine unattractive aesthetics.

The invention herein disclosed provides a solution to all of these problems with mounting rear carrier racks on ATVs with rear mounted and accessed fuel tanks. It provides an attractive rear mounted carrier rack useful for securing gear or cargo to the ATV that keeps the extra weight of the secured gear or cargo as close inward to the original length dimensions of the ATV as possible during riding while also maintaining access to the rear fuel filler inlet even when the carrier rack is in a loaded state.

### BRIEF SUMMARY OF THE INVENTION

It is the purpose of the invention described herein to provide all terrain vehicles (ATVs), manufactured with rear mounted and accessed fuel tanks, a horizontal rack structure to which gear and cargo can be secured and of which can be easily repositioned so that the rear mounted and accessed fuel filler inlet can be duly accessed when the aforementioned horizontal rack structure is in a loaded or unloaded state.

The invention described herein is embodied by: a mounting bracket that is rigidly fastened to multiple points on the rear frame of the ATV, an articulating mechanism comprised of multiple pivoting links attached to the aforementioned mounting bracket, a horizontal cargo carrying rack structure attached to the aforementioned articulating mechanism, and a means of latching the repositionable parts of the carrier rack system in a secure position suitable for vehicle operation.

### BRIEF DESCRIPTION OF THE DRAWINGS

FIG. 1 is an isometric view of the repositionable carrier rack assembly of the present invention, secured in its first extreme position suitable for vehicle operation, as it is attached to the rear of an all terrain vehicle (ATV).

FIG. 2 is a left hand side view of the repositionable carrier rack assembly that illustrates the invention's two extreme positions.

FIG. 3 is an isometric view of the repositionable carrier rack assembly in its second extreme position that illustrates all of its component parts.

### DETAILED DESCRIPTION OF THE INVENTION

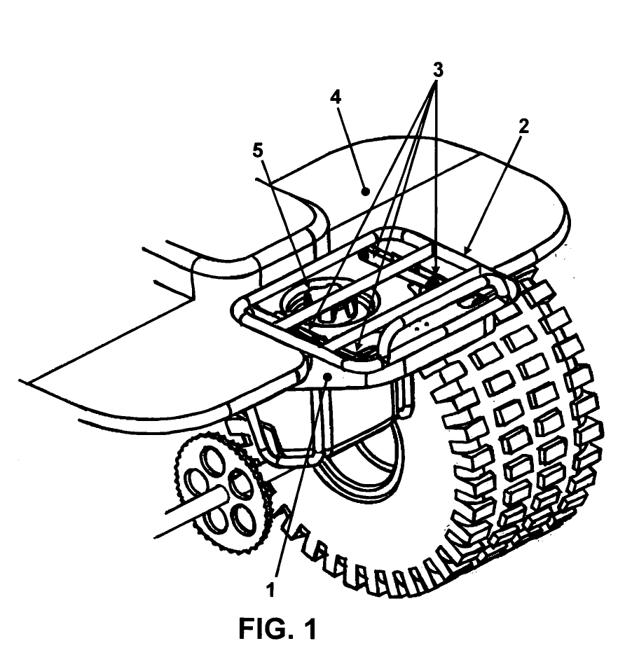

As seen in FIG. 1, the repositionable carrier rack assembly comprised of a horizontal cargo carrying rack structure 2, an articulating mechanism made up of four pivoting links 3, and a mounting bracket 1 is shown attached to the rear frame of an all terrain vehicle (ATV) 4. FIG. 1 also shows the placement of the rear mounted and accessed fuel filler inlet 5 directly beneath the horizontal cargo carrying rack structure 2 in relation to its most forward or first extreme position. FIG. 1 further illustrates the placement of the articulating mechanism comprised of four pivoting links 3 and the mounting bracket 1 as they relate to the most forward or first extreme position of the horizontal cargo carrying rack structure 2 and the placement of the rear mounted and accessed fuel filler inlet 5.

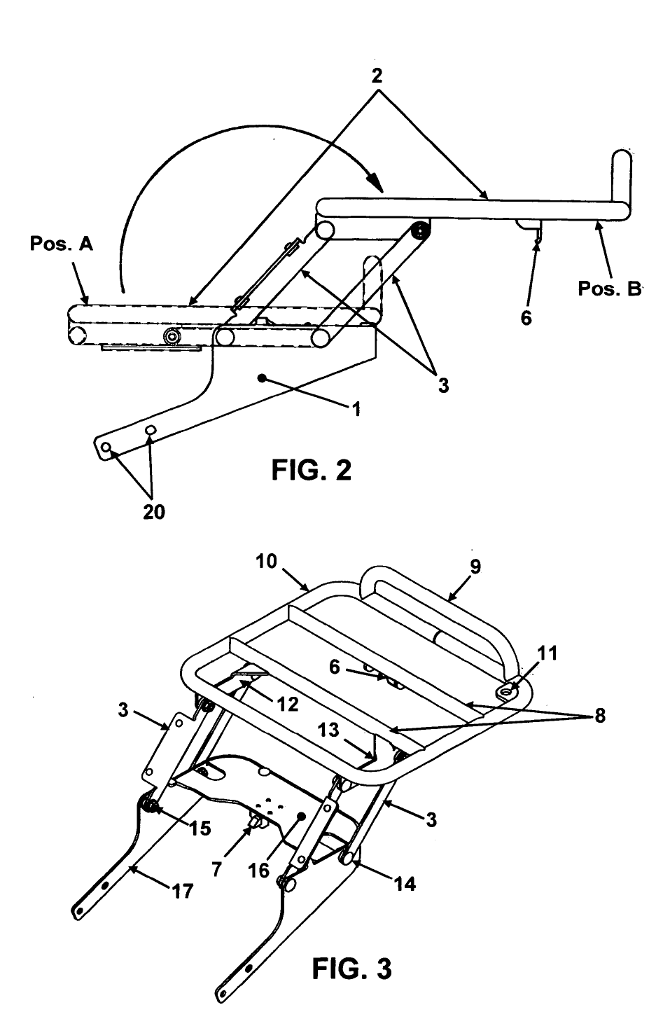

In FIG. 2, the two extreme positions A and B of the horizontal cargo carrying rack structure 2 are shown. Position A reflects the most forward or first extreme position of the horizontal cargo carrying rack structure 2 and position B reflects the most rearward or second extreme position of the horizontal cargo carrying rack structure 2. Position A also reflects the position in which the horizontal cargo carrying rack structure 2 is suitable for vehicle operation. Position B also reflects the position in which the horizontal cargo carrying rack structure 2 allows full access to the rear mounted and accessed fuel filler inlet 5 shown in FIG. 1. The repositionable carrier rack assembly allows multiple point rigid fastening to the frame of an ATV via the mounting holes 20 in the lower most ends of the mounting bracket 1.

FIG. 3 illustrates all of the component parts of the repositionable carrier rack assembly. The horizontal cargo carrying rack structure 2 shown in FIGS. 1 and 2 is to be constructed out of fabricated and welded tubular metal and sheet metal members shown in FIG. 3 to comprise: a horizontal perimeter tube formed into a generally rectangular shape with rounded corners 10; two straight tubes with notched ends 8 placed inside, spaced evenly amidst, and aligned parallel to the forward most and rearward most side tubes of the generally rectangular shaped horizontal perimeter tube 10; a right hand side formed sheet metal member 12 attached in a generally rightward location to a generally lower portion of the forward most side tube of the generally rectangular shaped horizontal perimeter tube 10 and in a generally rightward location to a generally lower portion as well as a generally lower to mid-height portion of the forward most straight tube with notched ends 8; a left hand side formed sheet metal member 13 attached in a generally leftward location to a generally lower portion of the forward most side tube of the generally rectangular shaped horizontal perimeter tube 10 and in a generally leftward location to a generally lower portion as well as a generally lower to mid-height portion of the forward most straight tube with notched ends 8; a formed generally U-shaped tube with notched ends 9 attached in a generally central location to a generally upper portion of the rearward most side tube of the generally rectangular shaped horizontal perimeter tube 10 in a generally vertical position parallel to the rearward most side tube of the generally rectangular shaped horizontal perimeter tube 10; and a plate metal member 11 attached in a generally forward and generally leftward location to a generally mid-height portion of the rearward most side tube of the generally rectangular shaped horizontal perimeter tube 10, as well as, attached in a generally rearward and generally rightward location to a generally mid-height portion of the leftward most side tube of the generally rectangular shaped horizontal perimeter tube 10.

FIGS. 1-3 show the articulating mechanism comprised by four pivoting sheet metal links 3 each of which have holes in both ends of their generally lengthwise embodiment to allow a jointed connection from one of the aforementioned holes in one end of each of the four pivoting sheet metal links 3 to one of four holes in a generally lower portion of the horizontal cargo carrying rack structure 2 and to allow a jointed connection from one of the aforementioned holes in the other end of each of the four pivoting sheet metal links 3 to one of four holes in a generally upper portion of the mounting bracket 1. In FIG. 3 the aforementioned jointed connections are shown to be made pivotal by securing eight bolts 14 through the jointed connection holes and fastening a locknut 15 to each of the eight bolts 14.

The mounting bracket structure 1 shown in FIGS. 1 and 2 is to be constructed out of fabricated and welded sheet metal members shown in FIG. 3 to comprise: a three-sided generally U-shaped formed sheet metal mounting bracket base member 17; and a flat K-shaped sheet metal gusset 16 attached in a generally horizontal manner in a generally central and generally rearward location to a generally upper portion of the sheet metal mounting bracket base member 17.

In FIG. 3 the components of a latching mechanism for securing the repositionable parts of the carrier rack system into the most forward or first extreme position are shown to comprise: a female latching component 6 constructed out of formed sheet metal and attached in a generally central location to a generally lower portion of the rearward most straight tube with notched ends 8; and a spring loaded slam type male latching component 7 attached in a generally forward most and a generally central location to a generally lower portion of the flat K-shaped sheet metal gusset 16.

It is to be understood that the previous description of the preferred embodiment of the invention disclosed herein is illustrative only and that other modifications thereof are possible within the scope of the following claims.

1. A carrier rack assembly, for an all terrain vehicle (ATV), in which a horizontal cargo carrying portion of said carrier rack assembly remains horizontal while said horizontal cargo carrying portion is able to be repositioned from a first extreme position to a second extreme position when said horizontal cargo carrying portion is in a loaded or empty state, said carrier rack assembly consisting of:
a) a mounting bracket that is rigidly fastened to multiple points on the rear frame of said ATV while said mounting bracket protrudes rearward and upward from said multiple fastening points on said ATV;
b) a horizontal cargo carrying rack structure that is positioned above said mounting bracket;
c) an articulating mechanism comprised of multiple pivoting links each of which are attached at one end to said mounting bracket by means of a jointed axial connection and each of which are attached at the other end to said horizontal cargo carrying rack structure by means of a jointed axial connection;
d) a latching mechanism that secures said articulating mechanism and said horizontal cargo carrying rack structure of said carrier rack assembly in a first extreme position in which said ATV can be operated.

2. A carrier rack assembly according to claim 1 that includes one or more spring mechanisms each of which have one end attached to one of the said pivoting links of the said articulating mechanism and the other end of each of the said spring mechanisms being attached to either the said mounting bracket or said horizontal cargo carrying rack structure of said carrier rack assembly, said spring mechanism providing mechanical assistance to the person repositioning said carrier rack assembly when said horizontal cargo carrying portion is in a loaded or empty condition.

3. A carrier rack assembly according to claim 1 that includes one or more pressurized strut mechanisms each of which have one end attached to one of the said pivoting links of the said articulating mechanism and the other end of each of the said pressurized strut mechanisms being attached to either the said mounting bracket or said horizontal cargo carrying rack structure of said carrier rack assembly, said pressurized strut mechanism providing mechanical assistance to the person repositioning said carrier rack assembly when said horizontal cargo carrying portion is in a loaded or empty condition.

4. A carrier rack assembly according to claim 1 that includes a rail structure attached in a generally centered and generally upper location to the rearward most portion of said cargo carrying rack structure, said rail structure providing a barrier to keep cargo items from tending to slide off of the back of said carrier rack assembly during use of said ATV.

5. A carrier rack assembly according to claim 1 that includes a flag mast attachment member integrated into said carrier rack assembly, said flag mast attachment member allowing a visibility flag to be attached to said ATV.
